(19) United States
(12) Patent Application Publication
(10) Pub. No.: US 2016/0180766 A1
(43) Pub. Date: Jun. 23, 2016

(54) DISPLAY PANEL AND DISPLAY DEVICE INCLUDING THE SAME

(71) Applicant: Samsung Display Co., Ltd., Yongin-City (KR)

(72) Inventor: Chang-Yeop Kim, Cheonan-si (KR)

(21) Appl. No.: 14/696,253

(22) Filed: Apr. 24, 2015

(30) Foreign Application Priority Data
Dec. 18, 2014 (KR) 10-2014-0182909

(51) Int. Cl. G09G 3/30

(52) U.S. Cl. CPC G09G 3/30; G09G 2320/0238; G09G 2330/021; G09G 2310/08

(57) ABSTRACT

Display panels and display devices including the display panels are disclosed. In one aspect, a display panel includes a gate driver configured to output a scan line enable signal based on an enable signal and a control signal configured to be determined based on resolution of display data, a data driver configured to output the display data based on the control signal, and a pixel array including a plurality of pixels configured to be enabled by a scan line enable signal and display an image corresponding to the display data.

### CROSS REFERENCE TO RELATED APPLICATION

This application claims priority under 35 U.S.C. §119 to Korean Patent Application No. 10-2014-0182909 filed on Dec. 18, 2014, in the Korean Intellectual Property Office (KIPO), the disclosure of which is hereby incorporated by reference herein in its entirety.

### BACKGROUND

1. Field

The described technology generally relates to a display panel and a display device including the display panel.

2. Description of the Related Technology

Display devices are being developed to have higher performance and higher speed. Research is being conducted to appropriately display image data on a pixel array according to a resolution of the respective image data.

### SUMMARY

One inventive aspect is a display panel that can increase performance by controlling a gate driver and a data driver based on a control signal that is determined by a resolution of display data.

Another aspect is a display device that can increase the performance by controlling the gate driver and the data driver based on the control signal that is determined by the resolution of the display data.

Another aspect is a display panel that includes a gate driver, a data driver and a pixel array. The gate driver provides a scan line enable signal based on an enable signal and a control signal determined by a resolution of display data. The data driver provides the display data based on the control signal. The pixel array displays the display data to pixels that are enabled by the scan line enable signal.

The gate driver can include a first gate driver and a second gate driver. The first gate driver can provide the scan line enable signal based on the enable signal. The second gate driver can provide the scan line enable signal based on the control signal.

The control signal can control the scan input signal that is provided to a plurality of scan line drivers included in the second gate driver.

The scan input signal can be controlled by providing the control signal to a gate of a control transistor included in each of the plurality of scan line drivers. The scan input signal can be transferred through the control transistor.

When the control signal is a first logic level, the control transistor can be turned off and block the scan input signal.

When the control signal is a second logic level, the control transistor can be turned on and transfer the scan input signal.

The first gate driver can include a plurality of scan line drivers. Each of the plurality of scan line drivers can include a control transistor. The enable signal can be provided to a gate of the control transistor.

The enable signal can be a second logic level.

When the control signal is a first logic level, the pixel array can be divided into an emitting region and a non-emitting region.

The non-emitting region can include a vertical non-emitting region and a horizontal non-emitting region. The vertical non-emitting region can be placed in same scan lines with the emitting region. The horizontal non-emitting region can be placed in different scan lines with the emitting region.

The first gate driver can provide the scan line enable signal to scan lines corresponding to the emitting region and the vertical non-emitting region.

The second gate driver can provide the scan line enable signal to scan lines corresponding to the horizontal non-emitting region.

The data driver can provide the display data to the emitting region and a predetermined voltage to the vertical non-emitting region.

The predetermined voltage can be a voltage corresponding to a black color.

The data driver can provide a predetermined voltage to the horizontal non-emitting region.

When the control signal is a second logic level, an entire region included in the pixel array can be an emitting region.

The data driver can provide the display data to the emitting region.

The display panel can further include a voltage providing circuit that provides a predetermined voltage to the pixel array based on the control signal.

When the control signal is a first logic level, the voltage providing circuit can provide a voltage corresponding to a black color to a vertical non-emitting region included in the pixel array.

Another aspect is a display device that includes a controller, a gate driver, a data driver and a pixel array. The controller provides a control signal and display data. The control signal is determined by a resolution of the display data. The gate driver provides a scan line enable signal based on an enable signal and the control signal. The data driver provides the display data based on the control signal. The pixel array displays the display data to pixels that are enabled by the scan line enable signal.

The display panel can increase the performance by controlling the gate driver and the data driver based on the control signal that is determined by the resolution of the display data.

Another aspect is a display panel comprising a gate driver configured to output a scan line enable signal based on an enable signal and a control signal configured to be determined based on resolution of display data, a data driver configured to output the display data based on the control signal, and a pixel array including a plurality of pixels configured to be enabled by a scan line enable signal and display an image corresponding to the display data.

In the above display panel, the gate driver includes a first gate driver configured to provide the scan line enable signal based on the enable signal and a second gate driver configured to provide the scan line enable signal based on the control signal.

In the above display panel, the second gate driver includes a plurality of scan line drivers each configured to control the scan input signal based on the control signal.

In the above display panel, each of the scan line drivers includes a control transistor including a gate configured to receive the control signal, wherein the control transistor is configured to transfer the scan input signal based on the control signal.

In the above display panel, when the control signal has a first logic level, the control transistor is further configured to be turned off so as to block the scan input signal.

In the above display panel, when the control signal has a second logic level, the control transistor is further configured to be turned on so as to transfer the scan input signal.

In the above display panel, the first gate driver includes a plurality of scan line drivers each including a control transistor configured to receive the enable signal.

In the above display panel, when the enable signal has a first logic level, the control transistor is further configured to block the scan input signal, and when the enable signal has a second logic level different from the first logic level, the control transistor is further configured to transfer the scan input signal.

In the above display panel, when the control signal has a first logic level, the pixel array is further configured to be divided into an emitting region and a non-emitting region different from the emitting region.

In the above display panel, the non-emitting region includes a vertical non-emitting region and a horizontal non-emitting region, wherein the vertical non-emitting region and the emitting region share the same scan lines, and wherein the horizontal non-emitting region and the emitting region share different scan lines.

In the above display panel, the first gate driver is further configured to transmit the scan line enable signal to the scan lines corresponding to the emitting region and the vertical non-emitting region.

In the above display panel, the second gate driver is further configured to transmit the scan line enable signal to the scan lines corresponding to the horizontal non-emitting region.

In the above display panel, the data driver is further configured to transmit the display data to the emitting region and supply a predetermined voltage to the vertical non-emitting region.

In the above display panel, the predetermined voltage has a voltage corresponding to the color black.

In the above display panel, the data driver is further configured to transmit a predetermined voltage to the horizontal non-emitting region.

In the above display panel, when the control signal has a second logic level, the entire pixel array corresponds to an emitting region.

In the above display panel, the data driver is further configured to transmit the display data to the emitting region.

In the above display panel, the display panel further includes a voltage providing circuit configured to supply a predetermined voltage to the pixel array based on the control signal.

In the above display panel, the pixel array includes a vertical non-emitting region, wherein, when the control signal has a first logic level, the voltage providing circuit is further configured to supply a voltage corresponding to the color black to the vertical non-emitting region.

Another aspect is a display device comprising a controller configured to provide display data and a control signal based on resolution of the display data and a display panel electrically connected to the controller. The display panel includes a gate driver configured to provide a scan line enable signal based on an enable signal and the control signal, a data driver configured to output the display data based on the control signal, and a pixel array including a plurality of pixels configured to be enabled by the scan line signal and display an image corresponding to the display data.

### BRIEF DESCRIPTION OF THE DRAWINGS

FIG. 1 is a block diagram illustrating a display panel according to example embodiments.

FIG. 2 a block diagram illustrating an example of a gate driver included in the display panel of FIG. 1.

FIG. 3 is a circuit diagram illustrating an example of a scan line driver included in a second gate driver of FIG. 2.

FIG. 4 is a circuit diagram illustrating an example of a scan line driver included in a first gate driver of FIG. 2.

FIG. 5 is a diagram illustrating an example of a pixel array included in the display panel of FIG. 1.

FIG. 6 is a diagram for describing an operation of the first gate driver of FIG. 2.

FIG. 7 is a diagram for describing an operation of the second gate driver of FIG. 2.

FIG. 8 is a diagram for describing an operation example of a data driver included in the display panel of FIG. 1.

FIG. 9 is a diagram for describing another operation example of the data driver included in the display panel of FIG. 1.

FIG. 10 is a diagram for describing still another operation example of the data driver included in the display panel of FIG. 1.

FIG. 11 is a block diagram illustrating a display panel according to an example embodiment.

FIG. 12 is a diagram illustrating a voltage providing circuit of an emitting region included in the display panel of FIG. 11.

FIG. 13 is a diagram illustrating a voltage providing circuit of a vertical non-emitting region included in the display panel of FIG. 11.

FIG. 14 is a block diagram illustrating a display device according to example embodiments.

FIG. 15 is a block diagram illustrating a mobile device according to example embodiments.

### DETAILED DESCRIPTION OF CERTAIN INVENTIVE EMBODIMENTS

The example embodiments are described more fully hereinafter with reference to the accompanying drawings. Like or similar reference numerals refer to like or similar elements throughout. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

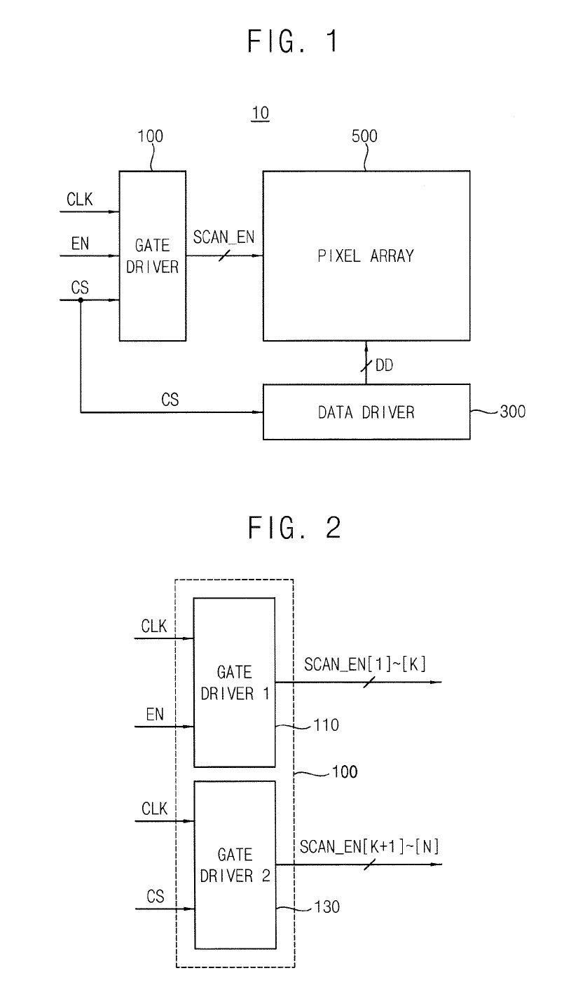

Referring to FIG. 1, a display panel 10 includes a gate driver 100, a data driver 300 and a pixel array 500. The gate driver 100 provides a scan line enable signal SCAN_EN based on an enable signal EN and a control signal CS determined by a resolution of display data DD. For example, the gate driver 100 provides a plurality of scan line enable signals SCAN_EN that are sequentially enabled based on the clock signal CLK, the control signal CS and the enable signal EN. The gate driver 100 can be implemented using a shift register. In addition, the control signal CS can be determined by the resolution of the display data DD that is received by the display panel 10. For example, when the resolution of the display data DD is 640*480, the control signal CS has a first logic level. In some embodiments, when the resolution of the display data DD is 1920*1080, the control signal CS is a second logic level. For example, the first logic level is a logic high level and the second logic level is a logic low level. The control signal CS, enable signal EN, and the clock signal CLK can be provided by a timing controller.

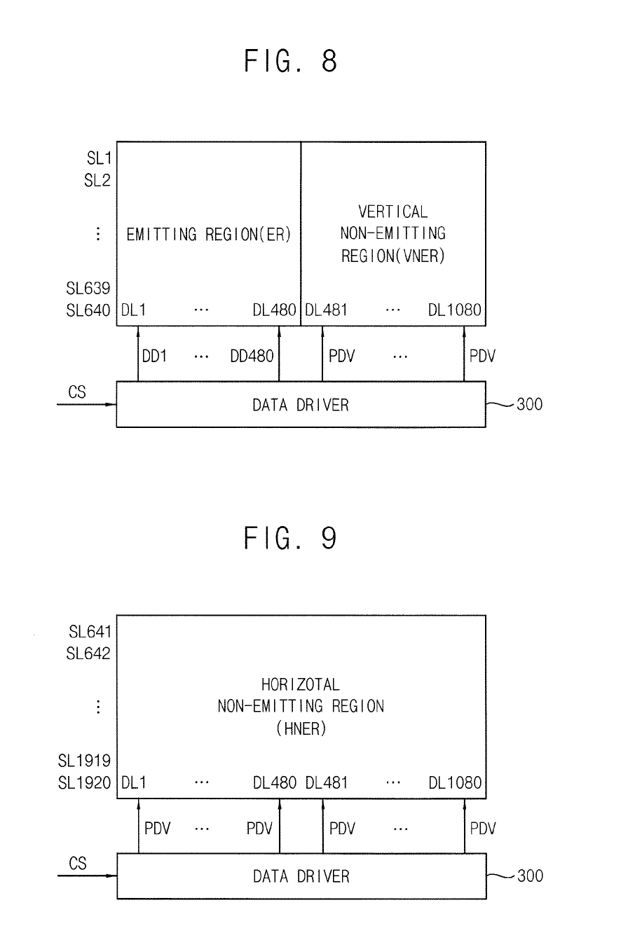

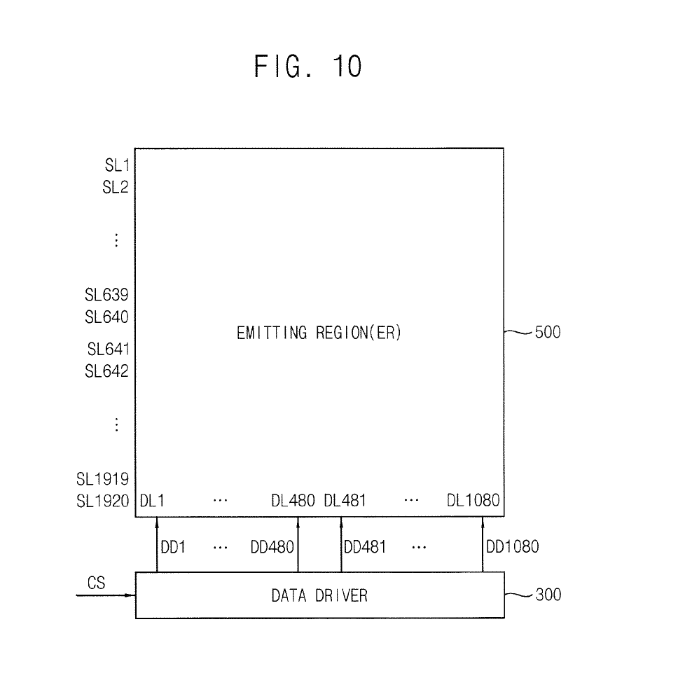

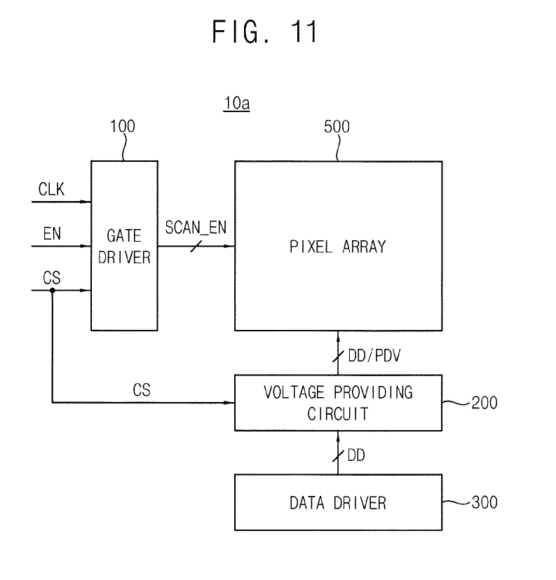

The data driver 300 provides the display data DD based on the control signal CS. As will be described in FIGS. 8 and 10, for example, when the control signal CS has the first logic level, the data driver 300 provides the display data DD to 480 data lines DL of 1080 data lines DL and provides a predetermined voltage PDV to 600 data lines DL of 1080 data lines DL. The predetermined voltage PDV can be a voltage corresponding to a black color. When the control signal CS has the second logic level, the data driver 300 can provide the display data DD to 1080 data lines DL.

The pixel array 500 displays the display data DD to pixels that are enabled by the scan line enable signal SCAN_EN. For example, when the control signal CS has the first logic level, the pixel array 500 is divided into an emitting region ER and a non-emitting region VNER, HNER. The non-emitting region can include a vertical non-emitting region VNER and a horizontal non-emitting region HNER. When the control signal CS has the first logic level, colors corresponding to the display data DD can be displayed in the pixels corresponding to the emitting region ER. In addition, when the control signal CS has the first logic level, color corresponding to the predetermined voltage PDV can be displayed in the pixels corresponding to the non-emitting region. The color corresponding to the predetermined voltage PDV can be the black.

The display panel 10 according to example embodiments can increase the performance by controlling the gate driver 100 and the data driver 300 based on the control signal CS that is determined by the resolution of the display data DD.

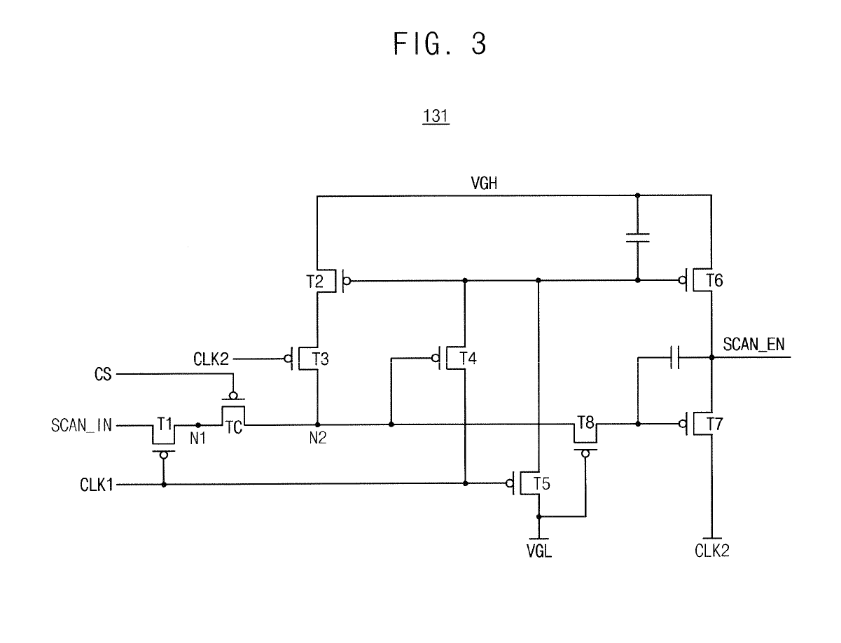

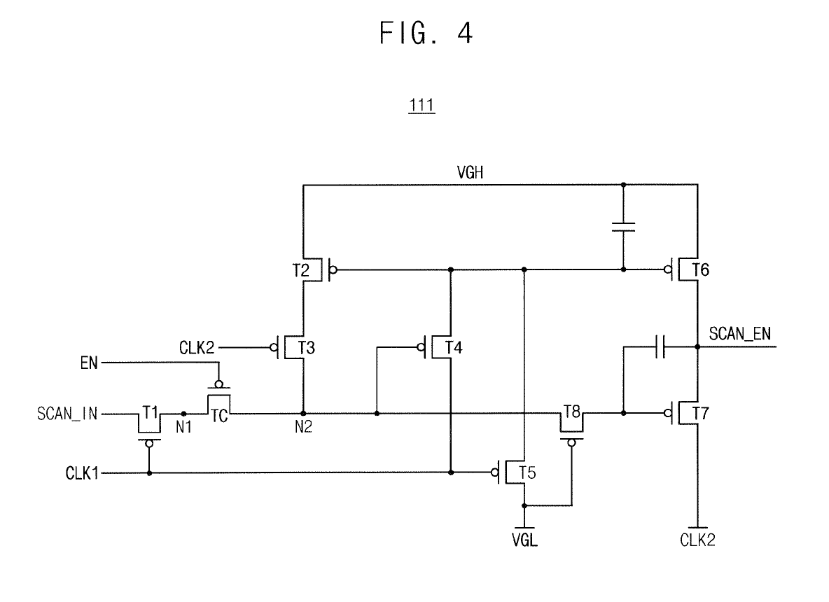

FIG. 2 a block diagram illustrating an example of a gate driver included in the display panel of FIG. 1. FIG. 3 is a circuit diagram illustrating an example of a scan line driver included in a second gate driver of FIG. 2. FIG. 4 is a circuit diagram illustrating an example of a scan line driver included in a first gate driver of FIG. 2.

Referring to FIGS. 2 to 4, the gate driver 100 includes a first gate driver 110 and a second gate driver 130. The first gate driver 110 can provide the scan line enable signal SCAN_EN based on the enable signal EN. The second gate driver 130 can provide the scan line enable signal SCAN_EN based on the control signal CS. Each of scan line drivers 131 included in the second gate driver 130 can include a plurality of transistors T1 to T7. For example, when the control signal CS and a first clock signal CLK1 have the logic low level, a scan input signal can turn on a seventh transistor T7 through a second node. In some embodiments, the scan input signal can turn on the seventh transistor T7 through the second node. The second clock signal CLK2 can be provided to a scan line. In this case, the scan line enable signal SCAN_EN can be the second clock signal CLK2. The scan line enable signal SCAN_EN can be the scan line input signal of the next scan line. In the same manner, the scan line enable signal SCAN_EN can be generated.

In an example embodiment, the control signal CS is used to control the scan input signal SCAN_IN that is provided to a plurality of scan line drivers 131 included in the second gate driver 130. For example, when the resolution of the display data DD that is received by the display panel 10 is 640*480, the control signal CS has the first logic level. In some embodiments, when the resolution of the display data DD that is received by the display panel 10 is 1920*1080, the control signal CS has the second logic level. The control signal CS can control the scan input signal SCAN_IN that is provided to a plurality of scan line drivers 131 included in the second gate driver 130. In an example embodiment, the scan input signal SCAN_IN that is provided to the first scan line driver may be provided from outside of the gate driver 100. In another example embodiment, the scan input signal SCAN_IN that is provided to the first scan line driver may be a K-th scan line enable signal SCAN_EN[K] that is provided from the first gate driver 110. For example, the plurality of scan line drivers 131 included in the second gate driver 130 may include a first scan line driver, a second scan line driver and a third scan line driver. An input of the first scan line driver may be the scan input signal SCAN_IN. In this case, an output of the first scan line driver may be the (K+1)-th scan line enable signal SCAN_EN[K+1], and the (K+1) scan line enable signal SCAN_EN[K+1] that is the output of the first scan line driver included in the second gate driver 130 may be provided to an input of the second scan line driver included in the second gate driver 130. The (K+1)-th scan line enable signal SCAN_EN[K+1] may be the scan input signal that is the input signal of second scan line driver included in the second gate driver 130. In the same manner, an output of the second scan line driver included in the second gate driver 130 may be the (K+2)-th scan line enable signal SCAN_EN[K+2], and the (K+2)-th scan line enable signal SCAN_EN[K+2] that is the output of the second scan line driver included in the second gate driver 130 may be provided to an input of the third scan line driver included in the second gate driver 130. The (K+2)-th scan line enable signal SCAN_EN[K+2] may be the scan input signal that is the input signal of third scan line driver included in the second gate driver 130. The same operation may be applied to the first gate driver 110.

In some embodiments, when the control signal CS has the first logic level, the control transistor TC can be turned off and block the scan input signal SCAN_IN. For example, when the control signal CS has the logic high level, the scan input signal SCAN_IN is not transferred from the first node to the second node through the control transistor TC. In this case, the scan line enable signal SCAN_EN can have the logic high level. For example, when the resolution of the display data DD is 640*480, the scan line enable signal SCAN_EN that is provided from the scan line drivers 131 included in the second gate driver 130 can have the logic high level. In this case, the scan line enable signal SCAN_EN that is provided from the scan line drivers 131 included in the second gate driver 130 can be disabled.

In some embodiments, when the control signal CS is a second logic level, the control transistor TC can be turned on and transfer the scan input signal SCAN_IN. For example, when the control signal CS has the logic low level, the scan input signal SCAN_IN is transferred from the first node to the second node through the control transistor TC. For example, when the resolution of the display data DD is 1920*1080, the scan line enable signal SCAN_EN that is provided from the scan line drivers 131 included in the second gate driver 130 has the logic low level. In this case, the scan line enable signal SCAN_EN that is provided from the scan line drivers 131 included in the second gate driver 130 can be enabled.

In some embodiments, the first gate driver 110 includes a plurality of scan line drivers 111. Each of the plurality of scan line drivers 111 can include a control transistor TC. The enable signal EN can be provided to a gate of the control transistor TC. For example, when the resolution of the display data DD is 640*480, voltages corresponding to display data DD are provided to the pixels that are connected to the scan lines SCAN_EN[1] to SCAN_EN[K] corresponding to the first gate driver 110. In addition, when the resolution of the display data DD is 1920*1080, the voltages corresponding to the display data DD are provided to the pixels that are connected to the scan lines SCAN_EN[1] to SCAN_EN[K] corresponding to the first gate driver 110. In this case, when the resolution of the display data DD is 640*480, the control transistor TC of the scan line driver 111 included in the first gate driver 110 is turned on. When the resolution of the display data DD is 1920*1080, the control transistor TC of the scan line driver 111 included in the first gate driver 110 can be turned on. Therefore, the enable signal EN can have the logic low level.

The scan input signal SCAN_IN can be controlled by providing the control signal CS to a gate of the control transistor TC included in each of the plurality of scan line drivers 131. The scan input signal SCAN_IN can be transferred through the control transistor TC.

The display panel 10 according to example embodiments can increase or enhance the performance by controlling the gate driver 100 and the data driver 300 based on the control signal CS that is determined by the resolution of the display data DD.

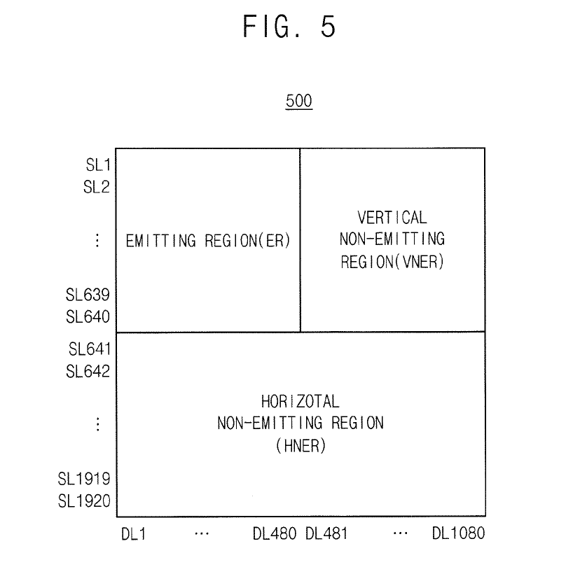

FIG. 5 is a diagram illustrating an example of a pixel array included in the display panel of FIG. 1.

Referring to FIG. 5, when the control signal CS has the first logic level, the pixel array 500 is divided into an emitting region ER and a non-emitting region. For example, when the resolution of the display data DD is 640*480, the control signal CS has the logic high level. The pixel array 500 can include 1920*1080 pixels. In this case, the scan lines corresponding to the emitting region ER can be from the scan line 1 SL1 to the scan line 640 SL640. The data lines DL corresponding to the emitting region ER can be from the data line 1 DL1 to the data line 480 DL480. The emitting region ER can be a region substantially surrounded by the scan lines corresponding to the emitting region ER and the data lines corresponding to the emitting region ER.

The non-emitting region can include a vertical non-emitting region VNER and a horizontal non-emitting region HNER. The vertical non-emitting region VNER can be placed in the same scan lines as the emitting region. The horizontal non-emitting region HNER can be placed in different scan lines from the emitting region. For example, the scan lines corresponding to the vertical non-emitting region VNER are from the scan line 1 SL1 to the scan line 640 SL640. The data lines DL corresponding to the vertical non-emitting region VNER can be from the data line 481 DL481 to the data line 1080 DL1080. The vertical non-emitting region VNER can be a region substantially surrounded by the scan lines corresponding to the vertical non-emitting region VNER and the data lines corresponding to the vertical non-emitting region VNER. The scan lines corresponding to the vertical non-emitting region VNER can be equal to the scan lines corresponding to the emitting region ER. For example, the scan lines corresponding to the horizontal non-emitting region HNER are from the scan line 641 SL641 to the scan line 1920 SL1920. The data lines DL corresponding to the horizontal non-emitting region HNER can be from the data line 1 DL1 to the data line 1080 DL1080. The horizontal non-emitting region HNER can be a region surrounded by the scan lines corresponding to the horizontal non-emitting region HNER and the data lines corresponding to the horizontal non-emitting region HNER. The scan lines corresponding to the horizontal non-emitting region HNER can be different from the scan lines corresponding to the emitting region ER.

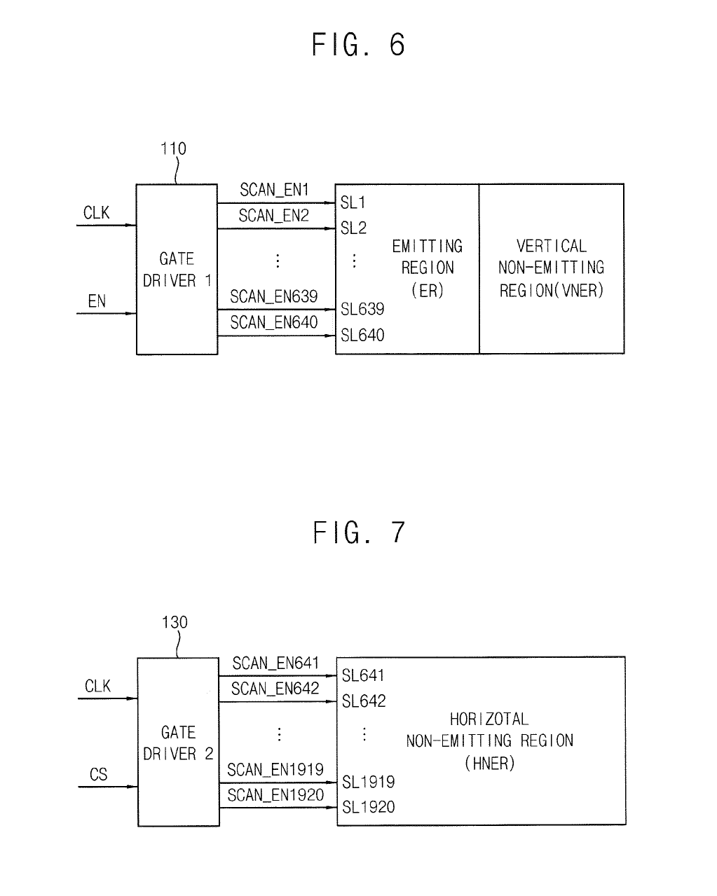

FIG. 6 is a diagram for describing an operation of the first gate driver of FIG. 2.

Referring to FIGS. 4 and 6, the first gate driver 110 includes a plurality of scan line drivers 111. The first gate driver 110 can provide the scan line enable signal SCAN_EN to scan lines corresponding to the emitting region ER and the vertical non-emitting region VNER. For example, when the resolution of the display data DD is 640*480, the control signal CS has the first logic level. The first logic level can have the logic high level. In this case, the enable signal EN can have the second logic level. The second logic level can have the logic low level. Even though the control signal CS has the logic high level, if the enable signal EN has the logic low level, the control transistor TC included in the scan line driver 111 of the first gate driver 110 can be turned on. When the control transistor TC included in the scan line driver 111 of the first gate driver 110 is turned on, the plurality of scan line enable signals SCAN_EN that are provided from the first gate driver 110 can sequentially enabled. For example, when the enable signal EN has the logic low level, the scan line driver 111 corresponding to the scan line 1 SL1 provides the scan line enable signal 1 SCAN_EN1 based on the scan input signal SCAN_IN. In addition, when the enable signal has the logic low level, the scan line driver 111 corresponding to the scan line 2 SL2 can provide the scan line enable signal 2 SCAN_EN2 based on the scan input signal SCAN_IN. In this case, the scan input signal SCAN_IN can be the scan line enable signal 1 SCAN_EN1. In the same manner, when the enable signal EN has the logic low level, the scan line driver 111 corresponding to the scan line 640 SL640 can provide the scan line enable signal 640 SCAN_EN640 based on the scan input signal SCAN_IN. In this case, the scan input signal SCAN_IN can be the scan line enable signal 639 SCAN_EN639.

For example, when the resolution of the display data DD is 1920*1080, the control signal CS has the second logic level. The second logic level can have the logic low level. In this case, the enable signal EN can have the second logic level. The enable signal EN can have the logic low level. If the enable signal EN has the logic low level, the control transistor TC included in the scan line driver 111 of the first gate driver 110 can be turned on. When the control transistor TC included in the scan line driver 111 of the first gate driver 110 is turned on, the plurality of scan line enable signals SCAN_EN can sequentially enabled. For example, when the enable signal EN has the logic low level, the scan line driver 111 corresponding to the scan line 1 SL1 can provide the scan line enable signal 1 SCAN_EN1 based on the scan input signal SCAN_IN. In addition, when the enable signal EN is the logic low level, the scan line driver 111 corresponding to the scan line 2 SL2 can provide the scan line enable signal 2 SCAN_EN2 based on the scan input signal SCAN_IN. In this case, the scan input signal SCAN_IN can be the scan line enable signal 1 SCAN_EN1. In the same manner, when the enable signal EN is the logic low level, the scan line driver 111 corresponding to the scan line 640 SL640 can provide the scan line enable signal 640 SCAN_EN640 based on the scan input signal SCAN_IN. In this case, the scan input signal SCAN_IN can be the scan line enable signal 639 SCAN_EN639. The control transistor TC included in the first gate driver 110 can be added to form the same structure as the scan line driver 131 included in the second gate driver 130.

The display panel 10 according to example embodiments can increase the performance by controlling the gate driver 100 and the data driver 300 based on the control signal CS that is determined by the resolution of the display data DD.

FIG. 7 is a diagram for describing an operation of the second gate driver of FIG. 2.

Referring to FIGS. 3 and 7, the second gate driver 130 includes a plurality of scan line drivers 131. The second gate driver 130 can provide the scan line enable signal SCAN_EN to scan lines corresponding to the horizontal non-emitting region HNER. For example, when the resolution of the display data DD is 640*480, the control signal CS has the first logic level. The first logic level can be the logic high level. When the control signal CS is the logic high level, the control transistor TC included in the scan line driver 131 of the second gate driver 130 can be turned off. When the control transistor TC included in the scan line driver 131 of the second gate driver 130 is turned on, the plurality of scan line enable signals SCAN_EN that are provided from the second gate driver 130 can be sequentially enabled. For example, when the control signal CS is the logic high level, the scan line driver 131 corresponding to the scan line 641 SL641 does not provide the scan line enable signal 641 SCAN_EN641 based on the scan input signal SCAN_IN. In addition, in some embodiments, when the control signal CS is the logic high level, the scan line driver 131 corresponding to the scan line 642 SL642 does not provide the scan line enable signal 642 SCAN_EN642 based on the scan input signal SCAN_IN. In this case, the scan input signal SCAN_IN can be the scan line enable signal 641 SCAN_EN641. In the same manner, in some embodiments, when the control signal CS is the logic high level, the scan line driver 131 corresponding to the scan line 1920 SL1920 does not provide the scan line enable signal 1920 SCAN_EN1920 based on the scan input signal SCAN_IN. In this case, the scan input signal SCAN_IN can be the scan line enable signal 1919 SCAN_EN1919.

For example, when the resolution of the display data DD is 1920*1080, the control signal CS has the second logic level. The second logic level can be the logic low level. In this case, the control signal CS can be the second logic level. The control signal CS can be the logic low level. If the control signal CS is the logic low level, the control transistor TC included in the scan line driver 131 of the second gate driver 130 can be turned on. When the control transistor TC included in the scan line driver 131 of the second gate driver 130 is turned on, the plurality of scan line enable signals SCAN_EN that are provided from the second gate driver 130 can be sequentially enabled. For example, when the control signal CS is the logic low level, the scan line driver 131 corresponding to the scan line 641 SL641 can provide the scan line enable signal 641 SCAN_EN641 based on the scan input signal SCAN_IN. In addition, when the control signal CS is the logic low level, the scan line driver 131 corresponding to the scan line 642 SL642 provides the scan line enable signal 642 SCAN_EN642 based on the scan input signal SCAN_IN. In this case, the scan input signal SCAN_IN can be the scan line enable signal 641 SCAN_EN641. In the same manner, when the control signal CS is the logic low level, the scan line driver 131 corresponding to the scan line 1920 SL1920 can provide the scan line enable signal 1920 SCAN_EN1920 based on the scan input signal SCAN_IN. In this case, the scan input signal SCAN_IN can be the scan line enable signal 1919 SCAN_EN1919.

FIG. 8 is a diagram for describing an operation example of a data driver included in the display panel of FIG. 1.

Referring to FIG. 8, the data driver 300 provides the display data to the emitting region ER and a predetermined voltage PDV to the vertical non-emitting region VNER. For example, when the resolution of the display data DD is 640*480, the control signal CS has the first logic level. The first logic level can be the logic high level. In this case, the data lines DL corresponding to the emitting region ER can be from the data line 1 DL1 to the data line 480 DL480. The data lines DL corresponding to the vertical non-emitting region VNER can be from the data line 481 DL481 to the data line 1080 DL1080. For example, when the control signal CS is the logic high level and the scan line enable signal 1 SCAN_EN1 is enabled, the pixels corresponding to the scan line 1 SL1 receive the display data DD and the predetermined voltage PDV from the data driver 300. In this case, the voltages corresponding to the display data DD can be provided to the pixels included in the region where the scan line 1 SL1 crosses the data lines DL corresponding to the emitting region ER. In addition, the predetermined voltage PDV can be provided to the pixels included in the region where the scan line 1 SL1 crosses the data lines DL corresponding to the vertical non-emitting region VNER. In a similar manner, when the control signal CS has the logic high level and the scan line enable signal 640 SCAN_EN640 is enabled, the pixels corresponding to the scan line 640 SL640 can receive the display data DD and the predetermined voltage PDV from the data driver 300. In this case, the voltages corresponding to the display data DD can be provided to the pixels included in the region where the scan line 640 SL640 crosses the data lines DL corresponding to the emitting region ER. In addition, the predetermined voltage PDV can be provided to the pixels included in the region where the scan line 640 SL640 crosses the data lines DL corresponding to the vertical non-emitting region VNER. Therefore, the data driver 300 can provide the display data to the emitting region ER and a predetermined voltage PDV to the vertical non-emitting region VNER.

In some embodiments, the predetermined voltage PDV is a voltage corresponding to the color black. For example, when the resolution of the display data DD is 640*480, the color that is displayed in the vertical non-emitting region VNER is black.

The display panel 10 according to example embodiments can increase the performance by controlling the gate driver 100 and the data driver 300 based on the control signal CS that is determined by the resolution of the display data DD.

FIG. 9 is a diagram for describing another operation example of the data driver included in the display panel of FIG. 1.

Referring to FIG. 9, the data driver 300 provides a predetermined voltage PDV to the horizontal non-emitting region HNER. For example, when the resolution of the display data DD is 640*480, the control signal CS has the logic high level. In this case, the data lines DL corresponding to the horizontal non-emitting region HNER can be from the data line 1 DL1 to the data line 1080 DL1080. In addition, the scan lines corresponding to the horizontal non-emitting region HNER can be from the scan line 641 SL641 to the scan line 1920 SL1920. For example, when the control signal CS is the logic high level, the scan line enable signal 641 SCAN_EN641 is not enabled. In this case, the color that is displayed in the pixels corresponding to the scan line 641 SL641 can be black. In addition, even though the scan line enable signal 641 SCAN_EN641 is enabled because of the malfunction of the display device, the pixels corresponding to the scan line 641 SL641 can receive the predetermined voltage PDV from the data driver 300. The predetermined voltage PDV can be a voltage corresponding to the color black. In some embodiments, when the control signal CS is the logic high level, the scan line enable signal 1920 SCAN_EN1920 is not enabled. In this case, the color that is displayed in the pixels corresponding to the scan line 1920 SL1920 can be black. In addition, even though the scan line enable signal 1920 SCAN_EN1920 is enabled because of the malfunction of the display device, the pixels corresponding to the scan line 1920 SL1920 can receive the predetermined voltage PDV from the data driver 300. The predetermined voltage PDV can be a voltage corresponding to the color black. Therefore, the data driver 300 can provide a predetermined voltage PDV to the horizontal non-emitting region HNER.

FIG. 10 is a diagram for describing still another operation example of the data driver included in the display panel of FIG. 1.

Referring to FIG. 10, when the control signal CS has the second logic level, an entire region included in the pixel array 500 is an emitting region ER. The data driver 300 can provide the display data DD to the emitting region ER. For example, when the resolution of the display data DD is 1920*1080, the control signal CS is the second logic level. The second logic level can be the logic low level. In this case, the scan lines corresponding to the emitting region ER can be from the scan line 1 SL1 to the scan line 1920 SL1920. The data lines DL corresponding to the emitting region ER can be from the data line 1 DL1 to the data line 1080 DL1080. For example, when the control signal CS is the logic low level and the scan line enable signal 1 SCAN_EN1 is enabled, the pixels corresponding to the scan line 1 SL1 can receive the display data DD from the data driver 300. In addition, when the control signal CS is the logic low level and the scan line enable signal 2 SCAN_EN2 is enabled, the pixels corresponding to the scan line 2 SL2 can receive the display data DD from the data driver 300. In a similar manner, when the control signal CS is the logic low level and the scan line enable signal 1920 SCAN_EN1920 is enabled, the pixels corresponding to the scan line 1920 SL1920 receive the display data DD from the data driver 300. Therefore, when the control signal CS has the second logic level, an entire region included in the pixel array 500 can be the emitting region ER.

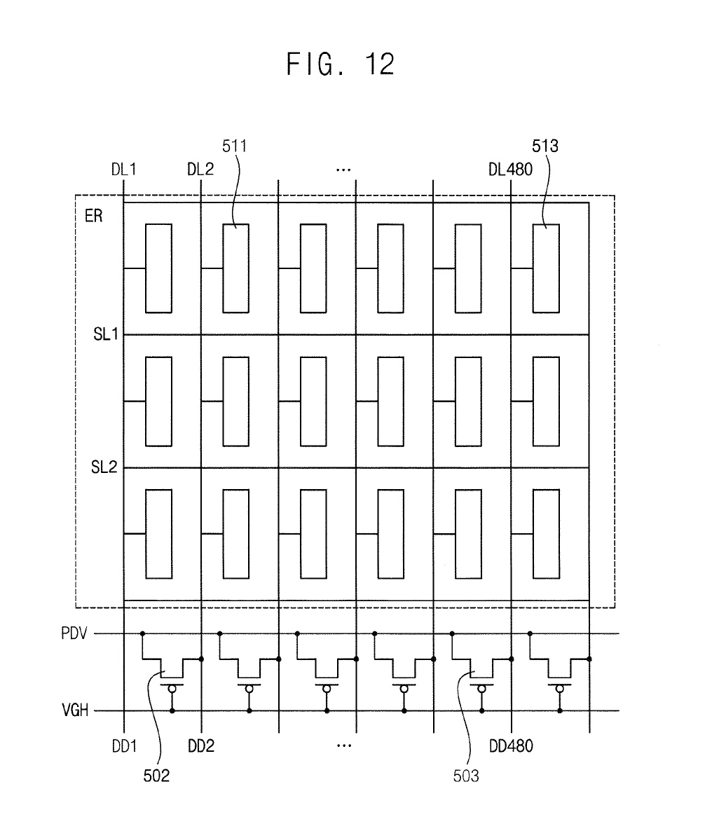

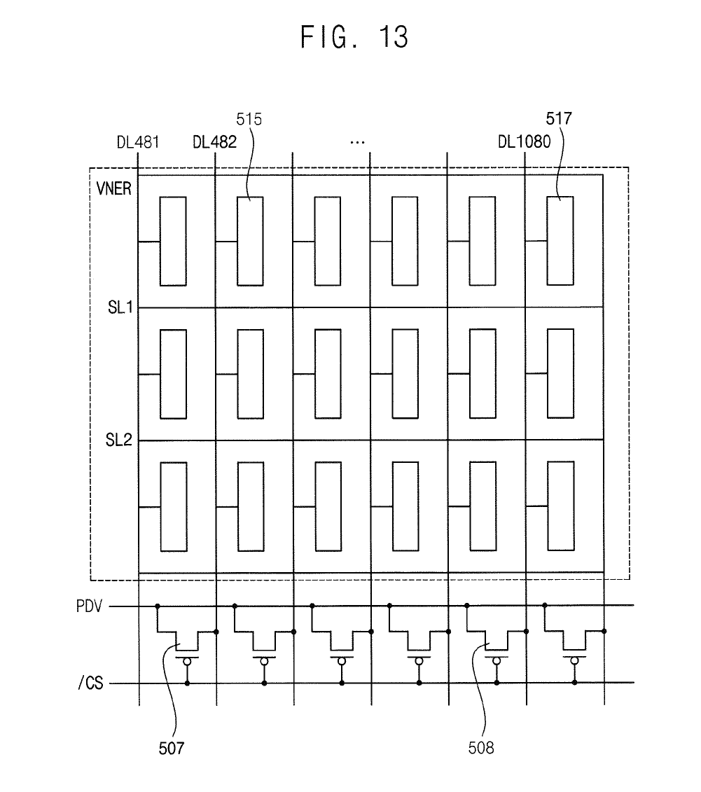

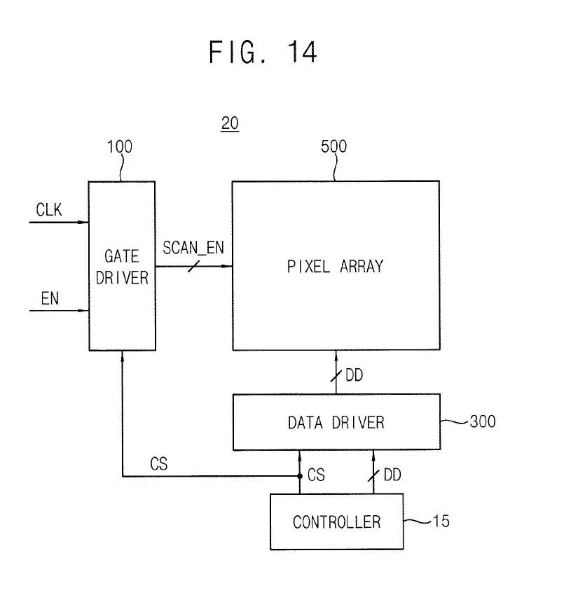

FIG. 11 is a block diagram illustrating a display panel according to an example embodiment. FIG. 12 is a diagram illustrating a voltage providing circuit of the emitting region included in the display panel of FIG. 11. FIG. 13 is a diagram illustrating a voltage providing circuit of a vertical non-emitting region included in the display panel of FIG. 11.

Referring to FIGS. 11 to 13, a display panel 10a includes a gate driver 100, a data driver 300 and a pixel array 500. The gate driver 100 provides a scan line enable signal SCAN_EN based on an enable signal EN and a control signal CS determined by a resolution of display data DD. The data driver 300 provides the display data DD based on the control signal CS. The pixel array 500 displays the display data DD to pixels that are enabled by the scan line enable signal SCAN_EN. In some embodiments, the display panel 10 further includes a voltage providing circuit 200 that provides a predetermined voltage PDV to the pixel array 500 based on the control signal CS.

In some embodiments, when the control signal CS has the first logic level, the voltage providing circuit 200 provides a voltage corresponding to the color black to a vertical non-emitting region VNER included in the pixel array 500. The first logic level can be the logic high level. The voltage providing circuit 200 corresponding to the emitting region ER can be operated based on the predetermined voltage PDV and the power supply voltage VGH. For example, the predetermined voltage PDV is a voltage corresponding to the color black. The power supply voltage VGH can be the logic high level. The power supply voltage VGH can be applied to a gate of the second voltage providing transistor 502 included in the voltage providing circuit 200 corresponding to the emitting region ER. When the power supply voltage VGH is applied to the gate of the second voltage providing transistor 502 included in the voltage providing circuit 200 corresponding to the emitting region ER, the second voltage providing transistor 502 can be turned off. In a similar manner, the power supply voltage VGH can be applied to a gate of the third voltage providing transistor 503 included in the voltage providing circuit 200 corresponding to the emitting region ER. When the power supply voltage VGH is applied to the gate of the third voltage providing transistor 503 included in the voltage providing circuit 200 corresponding to the emitting region ER, the third voltage providing transistor 503 can be turned off. Therefore, the voltage providing transistors included in the voltage providing circuit 200 corresponding to the emitting region ER can be turned off. The voltage providing transistors included in the voltage providing circuit 200 corresponding to the emitting region ER can be added to form the same structure as the voltage providing circuit 200 corresponding to the vertical non-emitting region VNER.

For example, when the resolution of the display data DD is 640*480, the control signal CS is a first logic level. The voltage providing circuit 200 corresponding to the vertical non-emitting region VNER can be operated based on the predetermined voltage PDV and the inversion control signal /CS. For example, the predetermined voltage PDV is a voltage corresponding to the color black. The control signal CS can be the logic high level. The inversion control signal /CS can be the logic low level. The inversion control signal /CS can be applied to a gate of the seventh voltage providing transistor 507 included in the voltage providing circuit 200 corresponding to the vertical non-emitting region VNER. When the inversion control signal /CS is applied to the gate of the seventh voltage providing transistor 507 included in the voltage providing circuit 200 corresponding to the vertical non-emitting region VNER, the seventh voltage providing transistor 507 can be turned on. When the seventh voltage providing transistor 507 is turned on and the scan line 1 SL1 is enabled, the predetermined voltage PDV can be provided to the seventh pixel 515 corresponding to the scan line 1 SL1 through the seventh voltage providing transistor 507. In a similar manner, the inversion control signal /CS can be applied to a gate of the eighth voltage providing transistor 508 included in the voltage providing circuit 200 corresponding to the vertical non-emitting region VNER. When the inversion control signal /CS is applied to the gate of the eighth voltage providing transistor 508 included in the voltage providing circuit 200 corresponding to the vertical non-emitting region VNER, the eighth voltage providing transistor 508 can be turned on. When the eighth voltage providing transistor 508 is turned on and the scan line 1 SL1 is enabled, the predetermined voltage PDV can be provided to the eighth pixel 517 corresponding to the scan line 1 SL1 through the eighth voltage providing transistor 508. Therefore, when the control signal CS has the first logic level, the voltage providing circuit 200 can provide a voltage corresponding to the color black to a vertical non-emitting region VNER included in the pixel array 500.

The display panel 10 according to example embodiments increases the performance by controlling the gate driver 100 and the data driver 300 based on the control signal CS that is determined by the resolution of the display data DD.

FIG. 14 is a block diagram illustrating a display device according to example embodiments.

Referring to FIG. 14, a display device 20 includes a controller 15, a gate driver 100, a data driver 300 and a pixel array 500. The controller 15 provides a control signal CS and display data DD. The control signal CS is determined by a resolution of the display data DD. The gate driver 100 provides a scan line enable signal SCAN_EN based on an enable signal EN and the control signal CS. For example, the gate driver 100 provides a plurality of scan line enable signals SCAN_EN that are sequentially enabled based on the clock signal CLK, the control signal CS and the enable signal EN. The gate driver 100 can be implemented using the shift register. In addition, the control signal CS can be determined by the resolution of the display data DD that is received by the display panel 10. For example, when the resolution of the display data DD is 640*480, the control signal CS has the first logic level. When the resolution of the display data DD is 1920*1080, the control signal CS can have the second logic level. For example, the first logic level is a logic high level and the second logic level is a logic low level.

The data driver 300 provides the display data DD based on the control signal CS. For example, when the control signal CS is the first logic level, the data driver 300 provides the display data DD to 480 data lines DL of 1080 data lines DL and provide a predetermined voltage PDV to 600 data lines DL of 1080 data lines DL. The predetermined voltage PDV can be a voltage corresponding to the color black. When the control signal CS is the second logic level, the data driver 300 can provide the display data DD to 1080 data lines DL.

The pixel array 500 displays the display data DD to pixels that are enabled by the scan line enable signal SCAN_EN. For example, when the control signal CS has the first logic level, the pixel array 500 is divided into an emitting region ER and a non-emitting region. The non-emitting region can include a vertical non-emitting region VNER and a horizontal non-emitting region HNER. When the control signal CS has the first logic level, colors corresponding to the display data DD can be displayed in the pixels corresponding to the emitting region ER. In addition, when the control signal CS is the first logic level, color corresponding to the predetermined voltage PDV can be displayed in the pixels corresponding to the non-emitting region. The color corresponding to the predetermined voltage PDV can be black.

The display panel 10 according to example embodiments increases the performance by controlling the gate driver 100 and the data driver 300 based on the control signal CS that is determined by the resolution of the display data DD.

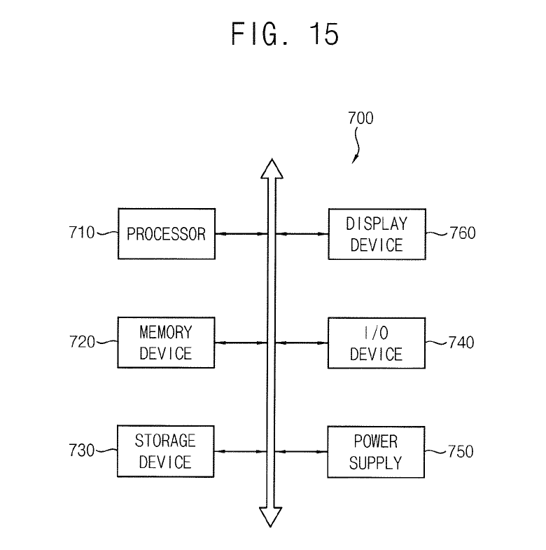

FIG. 15 is a block diagram illustrating a mobile device according to example embodiments.

Referring to FIG. 15, a mobile device 700 includes a processor 710, a memory device 720, a storage device 730, an input/output (I/O) device 740, a power supply 750, and an electroluminescent display device 760. The mobile device 700 can further include a plurality of ports for communicating a video card, a sound card, a memory card, a universal serial bus (USB) device, or other electronic systems.

The processor 710 can perform various computing functions or tasks. The processor 710 can be for example, a microprocessor, a central processing unit (CPU), etc. The processor 710 can be connected to other components via an address bus, a control bus, a data bus, etc. Further, the processor 710 can be coupled to an extended bus such as a peripheral component interconnection (PCI) bus.

The memory device 720 can store data for operations of the mobile device 700. For example, the memory device 720 includes at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, and/or at least one volatile memory device such as a dynamic random access memory (DRAM) device, a static random access memory (SRAM) device, a mobile dynamic random access memory (mobile DRAM) device, etc.

The storage device 730 can be, for example, a solid state drive (SSD) device, a hard disk drive (HDD) device, a CD-ROM device, etc. The I/O device 740 can be, for example, an input device such as a keyboard, a keypad, a mouse, a touch screen, and/or an output device such as a printer, a speaker, etc. The power supply 750 can supply power for operating the mobile device 700. The electroluminescent display device 760 can communicate with other components via the buses or other communication links.

The present embodiments can be applied to any mobile device or any computing device. For example, the present embodiments can be applied to cellular phones, smartphones, tablet computers, personal digital assistants (PDAs), portable multimedia players (PMPs), digital cameras, music players, portable game consoles, navigation systems, video phones, personal computers (PCs), server computers, workstations, laptop computers, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display panel comprising:
a gate driver configured to output a scan line enable signal based on an enable signal and a control signal configured to be determined based on resolution of display data;
a data driver configured to output the display data based on the control signal; and
a pixel array including a plurality of pixels configured to be enabled by a scan line enable signal and display an image corresponding to the display data.

2. The display panel of claim 1, wherein the gate driver includes:
a first gate driver configured to provide the scan line enable signal based on the enable signal; and
a second gate driver configured to provide the scan line enable signal based on the control signal.

3. The display panel of claim 2, wherein the second gate driver includes a plurality of scan line drivers each configured to control the scan input signal based on the control signal.

4. The display panel of claim 3, wherein each of the scan line drivers includes a control transistor including a gate configured to receive the control signal, and wherein the control transistor is configured to transfer the scan input signal based on the control signal.

5. The display panel of claim 4, wherein, when the control signal has a first logic level, the control transistor is further configured to be turned off so as to block the scan input signal.

6. The display panel of claim 5, wherein, when the control signal has a second logic level, the control transistor is further configured to be turned on so as to transfer the scan input signal.

7. The display panel of claim 2, wherein the first gate driver includes a plurality of scan line drivers each including a control transistor configured to receive the enable signal.

8. The display panel of claim 7, wherein, when the enable signal has a first logic level, the control transistor is further configured to block the scan input signal, and wherein, when the enable signal has a second logic level different from the first logic level, the control transistor is further configured to transfer the scan input signal.

9. The display panel of claim 2, wherein, when the control signal has a first logic level, the pixel array is further configured to be divided into an emitting region and a non-emitting region different from the emitting region.

10. The display panel of claim 9, wherein the non-emitting region includes a vertical non-emitting region and a horizontal non-emitting region, wherein the vertical non-emitting region and the emitting region share the same scan lines, and wherein the horizontal non-emitting region and the emitting region share different scan lines.

11. The display panel of claim 10, wherein the first gate driver is further configured to transmit the scan line enable signal to the scan lines corresponding to the emitting region and the vertical non-emitting region.

12. The display panel of claim 10, wherein the second gate driver is further configured to transmit the scan line enable signal to the scan lines corresponding to the horizontal non-emitting region.

13. The display panel of claim 11, wherein the data driver is further configured to transmit the display data to the emitting region and supply a predetermined voltage to the vertical non-emitting region.

14. The display panel of claim 13, wherein the predetermined voltage has a voltage corresponding to the color black.

15. The display panel of claim 12, wherein the data driver is further configured to transmit a predetermined voltage to the horizontal non-emitting region.

16. The display panel of claim 2, wherein, when the control signal has a second logic level, the entire pixel array corresponds to an emitting region.

17. The display panel of claim 16, wherein the data driver is further configured to transmit the display data to the emitting region.

18. The display panel of claim 1, wherein the display panel further includes a voltage providing circuit configured to supply a predetermined voltage to the pixel array based on the control signal.

19. The display panel of claim 18, wherein the pixel array includes a vertical non-emitting region, and wherein, when the control signal has a first logic level, the voltage providing circuit is further configured to supply a voltage corresponding to the color black to the vertical non-emitting region.

20. A display device comprising:
a controller configured to provide display data and a control signal based on resolution of the display data; and
a display panel electrically connected to the controller and including:
a gate driver configured to provide a scan line enable signal based on an enable signal and the control signal;
a data driver configured to output the display data based on the control signal; and
a pixel array including a plurality of pixels configured to be enabled by the scan line signal and display an image corresponding to the display data.
